(19) United States
(12) Patent Application Publication
(10) Pub. No.: US 2013/0060876 A1
(43) Pub. Date: Mar. 7, 2013

(54) REAL-TIME DATA TRANSMISSION SYSTEMS AND RELATED COMPUTER-IMPLEMENTED METHODS

(71) Applicant: Mark R. Janas, Raleigh, NC (US)

(72) Inventor: Mark R. Janas, Raleigh, NC (US)

(73) Assignee: In3, Inc.

(21) Appl. No.: 13/603,825

(22) Filed: Sep. 5, 2012

Related U.S. Application Data
(60) Provisional application No. 61/531,852, filed on Sep. 7, 2011.

(51) Int. Cl. G06F 15/16

(52) U.S. Cl. 709/206; 709/217

(57) ABSTRACT

Real-time data transmission systems and related methods are provided. Such systems may include a computer-implemented content management interface that includes a macro and/or a template configured to receive content-specific data entry, a subscriber database including subscriber data that includes at least one content-specific identifier, an advertisement database that is configured to manage advertisement data that includes at least one target identifier, and a data management engine. The data management engine may be in operative communication with the computer-implemented interface, the subscriber database, and/or the advertisement database. The data management engine may be configured to transmit content-specific data and advertisement data to one or more subscribers based on the subscriber data. The computer-implemented content management interface may include at least one administrative control associated with at least one administrative level.

### CLAIM OF PRIORITY

The present application claims the benefit of U.S. Provisional Patent Application Ser. No. 61/531,852, filed on Sep. 7, 2011, entitled Real-Time Data Transmission System and Computer-Implemented Method, the disclosure of which is incorporated herein in its entirety by reference.

### FIELD

The present disclosure relates to data transmission systems and computer-implemented data transmission methods.

### BACKGROUND

Advances in communication technology have fostered the rapid dissemination of information through various portals. Increased demand for real-time delivery of information has driven the advanced development of such technologies. Mobile communications devices (e.g., mobile telephones, personal digital assistants, etc.) now provide internet access, text-messaging services, and software applications for rapidly accessing and transmitting information. These devices and related technologies are further advancing in speed, capacity, and scope.

In many instances, however, programs that collect, process, and package information for delivery in real-time have not advanced to the same level as compared with communication technology. For example, real-time broadcast of information from sporting events (e.g., scores) may be unavailable, particularly where financial and other resource constraints limit such broadcasts. One such example includes high school sporting events that lack the audience and/or funding for such real-time transmission. Other examples include, but are not limited to, dissemination of company notices, weather alerts, and local government announcements.

In consequence, the art may continue to seek improvements in platforms and programs for the real-time transmission of information.

### SUMMARY

The present disclosure relates to real-time data transmission systems and related computer-implemented data transmission methods.

According to various embodiments, the disclosure relates to real-time data transmission systems secured through administrative controls. Such systems may include a computer-implemented content management interface that includes a macro and/or a template configured to receive and/or provide content-specific data entry, a subscriber database including subscriber data including at least one content-specific identifier, and an advertisement database that is configured to manage advertisement data that includes at least one target identifier. A data management engine may be in operative communication with the computer-implemented interface, subscriber database, and advertisement database, and may be configured to transmit content-specific data and advertisement data to one or more subscribers based on the subscriber data. The computer-implemented content management interface may include at least one administrative control associated with at least one administrative level. The content-specific data entry may be by and/or from a content provider.

In various embodiments, the disclosure relates to computer-implemented methods of real-time data transmission. Such methods may include accessing a real-time data transmission system through an administrative control, establishing a first-level content-specific data category in a computer-implemented content management interface, generating a second-level content-specific data associated with the first-level content-specific data category, using a data management engine to transmit the second-level content-specific data to one or more subscribers in a subscriber database, and transmitting to the one or more subscribers advertisement data including at least one target identifier. The at least one target identifier may be associated with the subscriber data, the at least one content-specific identifier, the first-level content-specific data category, and/or the second-level content-specific data. The subscriber data may include at least one content-specific identifier associated with the first-level content-specific data category and/or the second-level content-specific data.

Methods of operating a message gateway according to various embodiments of the present disclosure may include receiving a sports score of a live sporting event from a content provider at the message gateway. The content provider may be a user and/or electronic device that is physically located at the live sporting event. The content provider may have administrator access to the message gateway. The methods may include matching the sports score with a subscriber, using subscription data corresponding to the subscriber. The methods may include matching an advertisement with the sports score and/or the subscriber, using the subscription data corresponding to the subscriber and/or content data included with the sports score. The methods may include transmitting the sports score and the advertisement to an electronic device of the subscriber.

In various embodiments, matching the advertisement with the sports score and/or the subscriber may include matching the advertisement, using advertisement weighting data corresponding to the advertisement stored in the message gateway.

According to various embodiments, the advertisement may include a first advertisement. Some embodiments provide that the methods may include receiving an updated sports score of the live sporting event and/or matching the updated sports score with the subscriber, using the subscription data. The methods may include matching a second advertisement with the updated sports score and/or the subscriber, using the subscription data corresponding to the subscriber and/or content data included with the updated sports score. Some embodiments provide that the methods may include transmitting the updated sports score and the second advertisement to the electronic device of the subscriber.

In various embodiments, transmitting the sports score and the advertisement to the electronic device of the subscriber may include transmitting the sports score and the advertisement to the electronic device of the subscriber in a single electronic message.

According to various embodiments, the methods may include, before receiving the sports score, assigning one or more administrator levels that provide access to the message gateway, where the one or more administrator levels include an administrator level corresponding to the administrator access granted to the content provider.

Other aspects, features, and embodiments of the disclosure will be more fully apparent from the ensuing disclosure and appended claims.

### BRIEF DESCRIPTION OF THE DRAWINGS

The accompanying drawings, which form a part of the specification, illustrate various embodiments of the present invention. The drawings and description together serve to explain embodiments of the present invention.

FIG. 1A is a schematic illustration of a network that connects advertisers, content providers, and subscribers to a message gateway, according to various embodiments of the present invention.

FIG. 1B is a block diagram of the message gateway of FIG. 1A, according to various embodiments.

FIG. 1C is a block diagram that illustrates details of an exemplary processor and memory that may be used in accordance with some embodiments of the present invention.

FIGS. 2A-2G are flowcharts illustrating operations of the message gateway of FIG. 1A, according to various embodiments.

FIG. 3 is a block diagram illustrating system operations of the message gateway of FIG. 1A, according to various embodiments.

FIG. 4 is a block diagram of a display of an electronic device after receiving a message from the message gateway of FIG. 1A, according to various embodiments.

FIGS. 5A-5C illustrate lists of capabilities of different administrative levels for the message gateway of FIG. 1A, according to various embodiments.

### DETAILED DESCRIPTION

The present disclosure relates to real-time data transmission systems and related computer-implemented methods. In various particular aspects, an interface and data management engine may be provided for handling real-time data transmission, associated advertising, administrative controls, and systems and computer-implemented methods for the same.

Specific exemplary embodiments of the inventive concepts now will be described with reference to the accompanying drawings. The inventive concepts may, however, be embodied in a variety of different forms and should not be construed as limited to the embodiments set forth herein. Rather, these embodiments are provided so that this disclosure will be thorough and complete, and will fully convey the scope of the inventive concepts to those skilled in the art. In the drawings, like designations refer to like elements. It will be understood that when an element is referred to as being “connected,” “coupled,” or “responsive” to another element, it can be directly connected, coupled or responsive to the other element or intervening elements may be present. Furthermore, “connected,” “coupled,” or “responsive” as used herein may include wirelessly connected, coupled or responsive.

The terminology used herein is for the purpose of describing particular embodiments only and is not intended to be limiting of the inventive concepts. As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items. The symbol “/” is also used as a shorthand notation for “and/or.”

Unless otherwise defined, all terms (including technical and scientific terms) used herein have the same meaning as commonly understood by one of ordinary skill in the art to which these inventive concepts belong. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It will also be understood that although the terms “first” and “second” may be used herein to describe various elements, these elements should not be limited by these terms. These terms are only used to distinguish one element from another element. Thus, a first element could be termed a second element, and similarly, a second element may be termed a first element without departing from the teachings of the present inventive concepts.

Exemplary embodiments of the present invention may be embodied as methods and systems. Accordingly, exemplary embodiments of the present invention may be embodied in hardware and/or in software (including firmware, resident software, micro-code, etc.). Furthermore, exemplary embodiments of the present invention may take the form of a computer program product comprising a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, or device. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Some aspects of the present invention may be implemented in a “cloud” computing environment. Cloud computing is a computing paradigm where shared resources, such as processor(s), software, and information, are provided to computers and other devices on demand typically over a network, such as the Internet. In a cloud computing environment, details of the computing infrastructure, e.g., processing power, data storage, bandwidth, and/or other resources are abstracted from the user. The user does not need to have any expertise in or control over such computing infrastructure resources. Cloud computing typically involves the provision of dynamically scalable and/or virtualized resources over the Internet. A user may access and use such resources through the use of a Web browser. A typical cloud computing provider may provide an online application that can be accessed over the Internet using a browser. The cloud computing provider, however, maintains the software for the application and some or all of the data associated with the application on servers in the cloud, i.e., servers that are maintained by the cloud computing provider rather than the users of the application.

Exemplary embodiments of the present invention are described herein with reference to flowchart and/or block diagram illustrations. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means and/or circuits for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the functions specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

The phrase “computer-implemented” as used herein refers to use of any software, data or digital information carrier, e.g., article incorporating software or other machine instructions for computing operation, and/or programmable machine that receives input, stores and manipulates data, and provides output in a useful format. Computer-implemented includes, but is not limited to, software, programs, and any other application used or useful on or in communication with a computer (e.g., desktop computer, home computer, laptop computer, personal digital assistant (PDA), portable computer, tablet PC, wearable computer, mobile device) or server.

The phrases “real-time data transmission” and “transmission” as used herein refer to any known or conceived mechanism for transmitting information electronically and/or in real-time, including, but not limited to, any one or more of Short Message Service (SMS), Multimedia Messaging Service (MMS), email, mobile applications, and web page delivery. Such real-time data transmission may be made to or from a computer, including a mobile device, which may also be referred to as a client terminal.

Various embodiments described herein may provide real-time electronic updates of events (e.g., high school, small college, or minor league sporting events) for which real-time updates may be uncommon or logistically challenging. Moreover, each of the real-time updates may be accompanied by an electronic advertisement, which may provide a source of revenue for advertisers and/or organizations participating in the events.

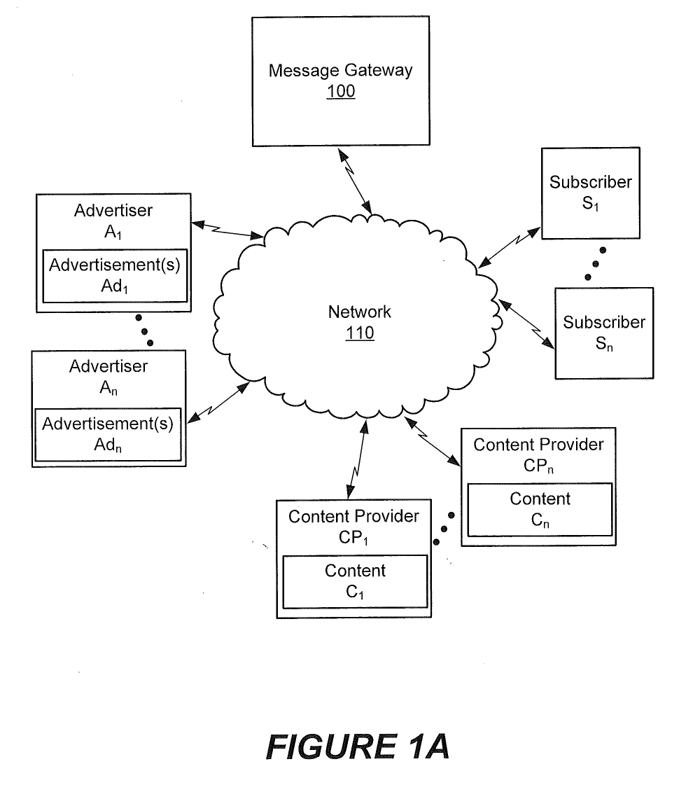

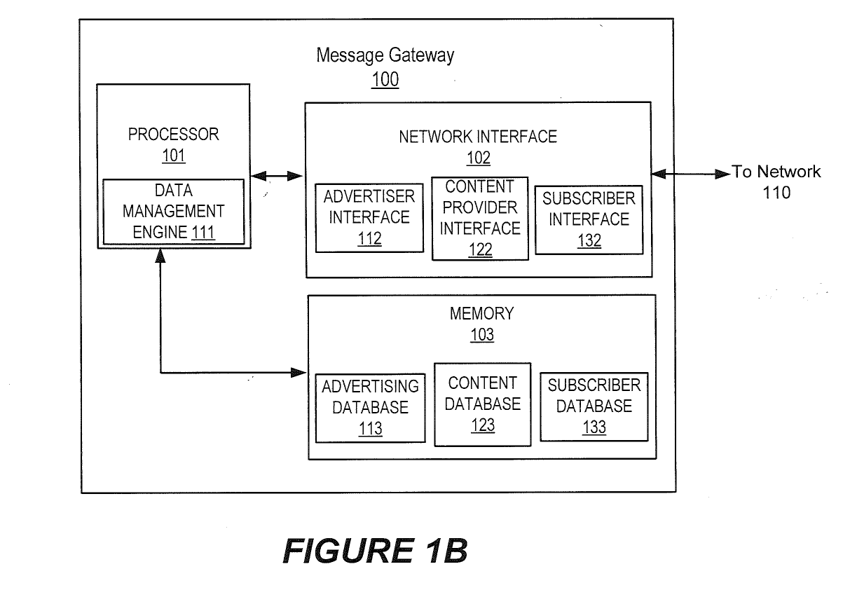

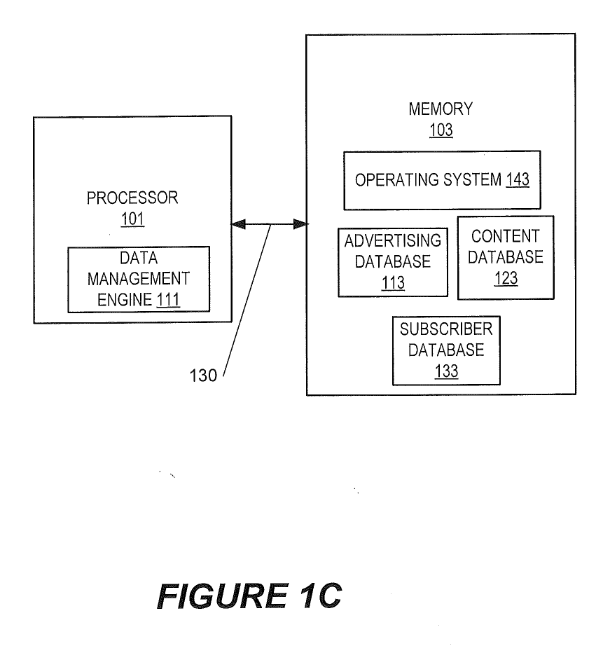

Referring now to FIG. 1A, a schematic illustration is provided of a network 110 that connects advertisers A₁-Aₙ, content providers CP₁-CPₙ, and subscribers S₁-Sₙ, to a message gateway 100, according to various embodiments. The network 110 may include the Internet, as well as private networks such as intranets. Additionally or alternatively, the network 110 may include a wireless (e.g., cellular or WLAN) network and/or a wired (e.g., cable or fiber optic) network. The subscribers S₁-Sₙ may connect to the network 110 using electronic devices such as computers, televisions, and/or mobile phones, among others. The computers may include desktop, laptop, netbook, tablet computers, and the like. Moreover, it will be understood that an advertiser A described herein shall refer to any one of the advertisers A₁-Aₙ. Similarly, a subscriber S shall refer to any one of the subscribers S₁-Sₙ, and a content provider CP shall refer to any one of the content providers CP₁-CPₙ.

The advertisers A₁-Aₙ may have respective advertisements Ad₁-Adₙ, which may be stored electronically in databases operated by the advertisers A₁-Aₙ or by third parties. The advertisements Ad₁-Adₙ may include advertisement data such as text, images, and/or contact information. For example, the text may be “Shop at our store!,” the images may include logos and/or pictures of an advertiser A's products or services, and the contact information may include a hyperlink, phone number, email address, or street address.

An advertiser A may create an advertiser account with the message gateway 100 before providing an advertisement Ad to the message gateway 100. The advertiser A may also purchase text advertisement credits or utilize advertisement credits to set up new advertisements. Moreover, the advertiser A may set up and target advertisements by sport, area code(s), zip code(s), state, and/or custom geographic region. Furthermore, the advertiser A may run reports by advertisement Ad and date range to monitor advertisement Ad performance.

The content providers CP₁-CPₙ may provide respective content C₁-Cₙ to the message gateway. The content C₁-Cₙ may include content-specific data within a content-specific data category. The phrase “content-specific data category” as used herein refers to a category of data, including, but not limited to, a school, league, conference, team, company, organization, and/or government entity. The phrase “content-specific data” as used herein refers to the type of data within a category, including, but not limited to, a score, game update (e.g., summary/highlights), media report, weather report, medical alert, weather alert, announcement, and/or notice. Moreover, the phrase “content-specific data” as used herein refers to data that is defined by one or more characteristics that allow for computer-implemented categorization.

As an example, the content-specific data category may be a high school football team, and the content-specific data may include the high school football team's schedule, scores, and related information with which a subscriber S desires real-time updates. Moreover, although content C may be transmitted by the message gateway 100 using a real-time method such as MMS, it will be understood that a content provider CP may transmit the content C in real-time or may delay its transmission of the content C to the message gateway 100. For example, the content provider CP may delay its transmission of a football score by a few minutes or by one-half of an hour. A subscriber S may be, for example, a parent of a student on the high school football team. Information indicating that the subscriber S desires updates regarding the high school football team may be provided by the subscriber S and may be saved by the message gateway 100 as subscriber data to signal/trigger transmission of such content-specific data (e.g., high school football scores) for each game. For example, the subscriber data and/or at least one content-specific identifier may include information relating to and/or associated with content-specific data, such that the content-specific data may be properly directed to a subscriber S.

Content-specific data entry (e.g., by a content provider CP) may be made manually or through an automatic method. For example, content-specific data entry may be made automatically by connecting a computer-implemented content management interface to a data entry control by way of a direct-connect portal. In various embodiments, a data entry control includes any one or more of a scoreboard, scoreboard controller, emergency alert system, academic alert system, weather alert system, news alert system, switchboard, and messaging system, among others. The content-specific data category may include data by and/or for any one or more of sports, medical, academic, corporate, organizational (e.g., non-profit, religious), and/or governmental entities.

For example, entry of content-specific data may be made by a content provider CP utilizing a computer-implemented content management interface (e.g., an interface with the message gateway 100) through a macro and/or a template. As an example, high school football scores may be transmitted following entry thereof to the subscriber S (e.g., a subscriber terminal of the subscriber S) via a data management engine (e.g., a data management engine 111 as illustrated in FIG. 1B) in operative communication with a computer-implemented interface.

A “subscriber” S as used herein may include any person or entity capable of receiving and understanding information and/or communications, and who has subscribed to the messaging service(s) of the message gateway 100 disclosed herein. In various embodiments, a subscriber S may desire information from a particular source or about a particular topic (e.g., content category). The subscriber S may provide certain data/information about itself when subscribing or using the disclosed messaging service(s).

Such “subscriber data” may include at least one content-specific identifier, which may include content that is of interest to the subscriber S. The content-specific identifier(s) may include the subscriber S's name, address, telephone number, account number, email address, parental information, student information, teacher information, sports interest information, alumni information, coach information, administrator information, fantasy league information, hobbies, mobile number, company information, academic information, medical information, organization information, and/or religious information.

Subscriber data may be included in a subscriber database (e.g., a subscriber database 133 as illustrated in FIG. 1B). The term “database” as used herein refers to any system adapted to organize, store, and retrieve data, where the database may be managed and/or accessed using a database management engine (e.g., a database management engine 111 as illustrated in FIG. 1B) or database management system. The term “database management system” (DBMS) as used herein refers generally to software that operates a database, providing storage, access, security, backup, and/or other utilities regarding the data. Database management systems are generally categorized according to the database model that they support, such as relational or Extensible Markup Language (XML), the type(s) of computer they support, such as a server cluster or a mobile device, and the query language(s) that access the database, such as Structured Query Language (SQL) or XQuery. Examples of some commonly used DBMS are MySQL, PostgreSQL, Microsoft Access, SQL Server, FileMaker, Oracle, Sybase, dBASE, Clipper, FoxPro, etc. A DBMS as disclosed herein may include an Open Database Connectivity (ODBC) driver that allows the database to integrate with other databases.

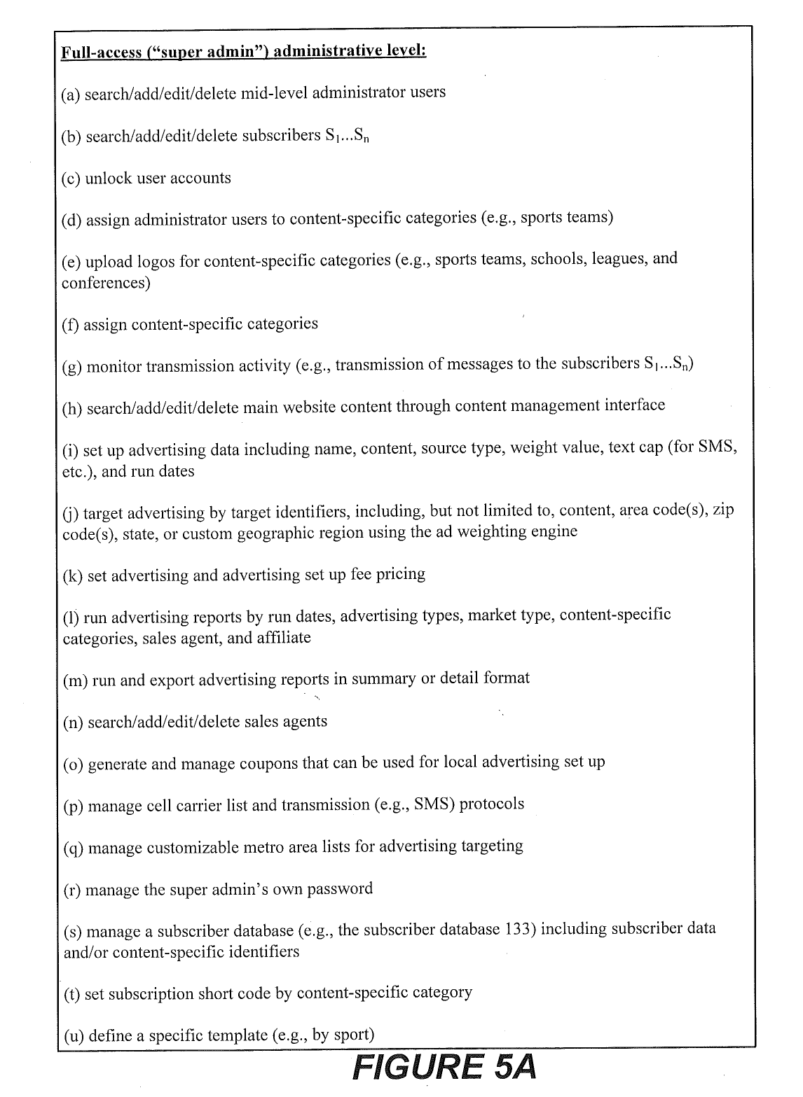

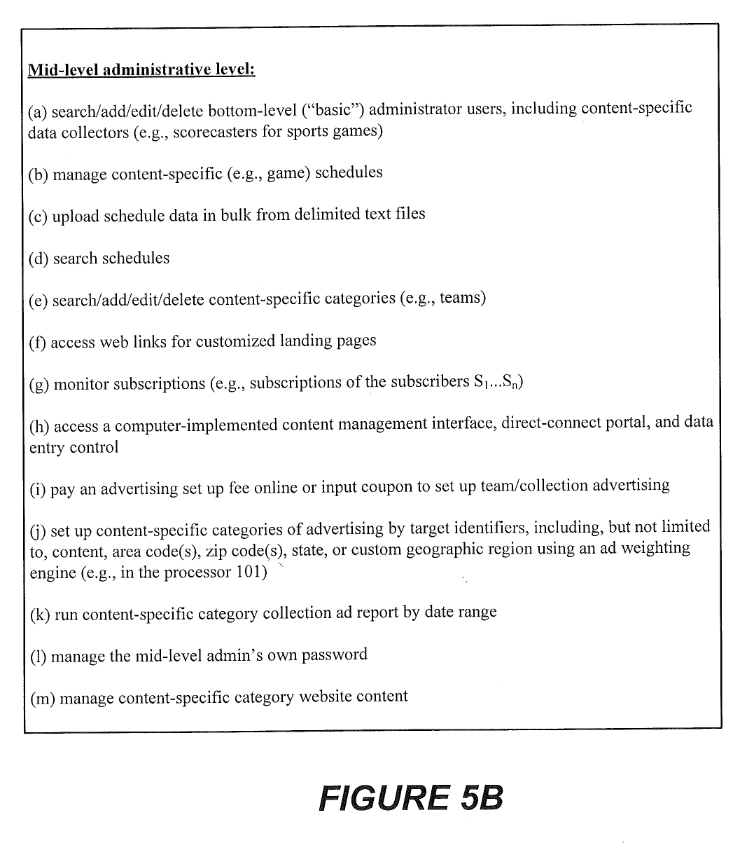

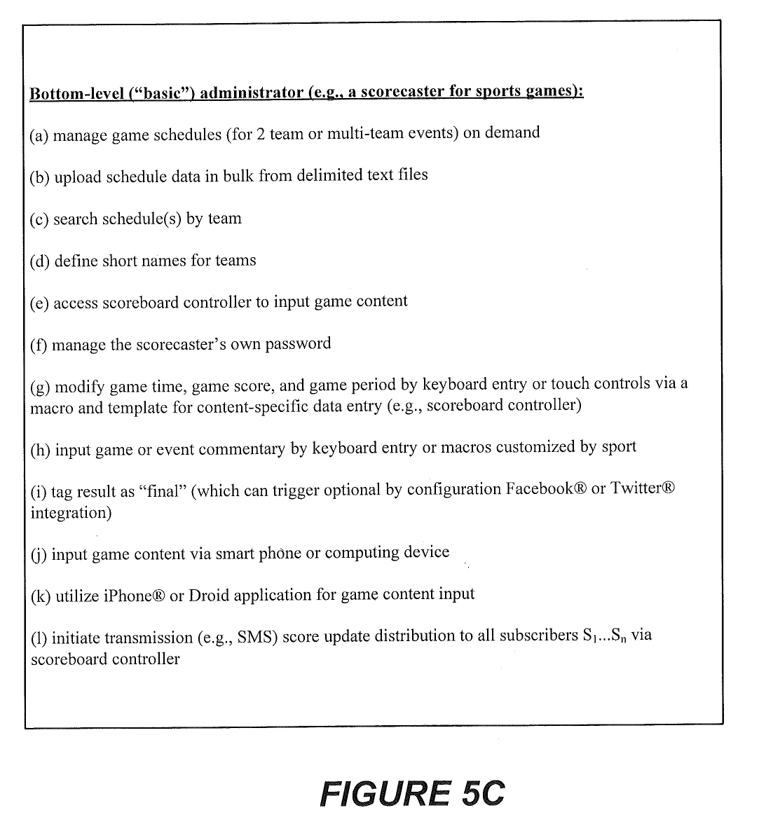

A subscriber S may create its own subscription account(s) by providing subscriber data such as an email address, password, name, zip code, mobile number, carrier, and additional optional profile information (which may be defined by the “super admin” illustrated in FIG. 5A). The subscriber S may also access Terms of Use and Privacy Policy. Moreover, the subscriber S may search for content-specific categories of data and/or information in the system (e.g., the message gateway 100) and add/modify/remove content-specific categories (e.g., teams) to/from the subscriber S's subscription. The subscriber S may additionally manage and modify password information, as well as mobile number, carrier, and device type. The subscriber S may also access real-time data updates (e.g., a live scoreboard for game monitoring and/or SMS advertisement content adjacent the live scoreboard). Moreover, the subscriber S may utilize a web portal or smart phone (e.g., iPhone/Droid) application for real-time data updates, and may subscribe by transmission (e.g., of a SMS message) to one or more services of the message gateway 100.

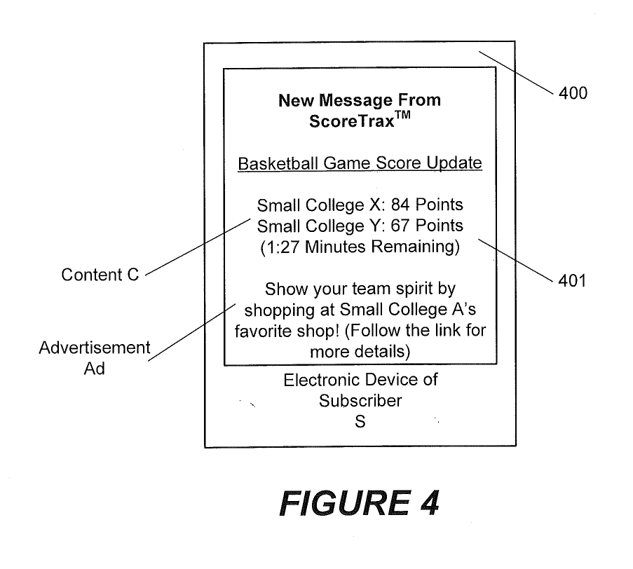

The phrase “subscriber terminal” as used herein refers to any computer or mobile device (e.g., handheld device) including, but not limited to, an Apple® iPhone® and/or iPad®, a Research in Motion® Blackberry®, or a Motorola® DROID® digital communications device. In various embodiments, a remote subscriber terminal may include a computer-implemented content display interface for displaying content-specific data received as a result of a real-time data transmission. For example, an electronic device 400 of a subscriber S is illustrated in FIG. 4 as including a display 401.

The term “interface” as used herein refers to an interaction between components (both hardware and software) that allows one component to function independently while communicating with other components via an input/output system and an associated protocol. For example, a computer-implemented content display interface receives and displays content-specific data, often on a subscriber terminal. In various embodiments, a computer-implemented content display interface includes software running on a subscriber terminal that displays content-specific data. In various embodiments, a computer-implemented content management interface is utilized for data entry and/or handling. A computer-implemented content management interface may include any one or more of a macro and template that is specific to the category and/or content of the content-specific data. Macros and/or templates may be provided for handling the various kinds and categories of data and communications, and are well known in the art.

Referring now to FIG. 1B, a block diagram is provided of the message gateway 100 of FIG. 1A, according to various embodiments. In particular, FIG. 1B illustrates that the message gateway 100 may include a network interface 102 that is configured to provide a communication interface with the network 110. The communication interface may be used with wired and/or wireless communications with the network 110.

The electronic device 100 may further include a processor 101 that is coupled to the network interface 102. The processor 101 may be configured to communicate with the advertisers A₁-Aₙ, content providers CP₁-CPₙ, and subscribers S₁-Sₙ via the network interface 102. For example, the network interface 102 may include an advertiser interface 112 for communicating with the advertisers A₁-Aₙ, a content provider interface 122 for communicating with the content providers CP₁-CPₙ, and a subscriber interface 132 for communicating with the subscribers S₁-Sₙ. As an example, the advertiser interface 112 may be configured to receive the advertisements Ad₁-Adₙ and the content provider interface 122 may be configured to receive the content C₁-Cₙ. Moreover, the subscriber interface 132 may be configured to receive subscriber/subscription data from the subscribers S₁-Sₙ, and/or to transmit the advertisements Ad₁-Adₙ and the content C₁-Cₙ to the subscribers S₁-Sₙ.

The message gateway 100 may also include a memory 103 that is coupled to the processor 101. The memory 103 may include an advertising database 113 that receives and stores advertisements Ad₁-Adₙ from the advertisers A₁-Aₙ. The memory 103 may also include a content database 123 that receives and stores content C₁-Cₙ from the content providers CP₁-CPₙ, and a subscriber database 133 that receives and stores subscriber data from the subscribers S₁-Sₙ. Moreover, the processor 101 may include a data management engine 111 that is configured to process data received from the network interface 102 and/or data stored in the memory 103.

The memory 103 may also store instructions/algorithms used to match content C₁-Cₙ from the content providers CP₁-CPₙ with the subscribers S₁-Sₙ. Additionally, the memory 103 may store instructions/algorithms used to match advertisements Ad₁-Adₙ with the content C₁-Cₙ and/or the subscribers S₁-Sₙ. Moreover, it will be understood that the message gateway 100 may include a single processor or a combination of processors. In particular, the message gateway 100 may be used in a cloud computing environment. For example, the advertising database 113 may be distributed/stored among different servers/processors.

In various embodiments, the advertising database 113 may include advertisement data including at least one target identifier. The term “target identifier” as used herein refers to an indicator relevant to any one or more of a specific type or category of subscriber, subscriber data, content-specific information and/or category, and a content-specific identifier. A target identifier may be associated with or related to subscriber data so that advertisements Ad₁-Adₙ are directed to specific subscribers S₁-Sₙ. For example, a subscriber S may identify an area code or zip code during a subscription initiation process, as advertisers A₁-Aₙ local to the subscriber S may be interested in directing their advertisements Ad₁-Adₙ to the particular subscriber S.

The advertisement data included in the advertising database 113 may include other data or information such as weighting values, dates for transmission, or similar information to identify when such advertisements Ad₁-Adₙ are to be transmitted, and to whom. The “weighting value” is a score or numerical identifier given to or associated with an advertisement Ad to identify when and how the advertisement Ad is to be transmitted. For example, an advertisement Ad₁ having a high weighting value may be circulated more frequently than an advertisement Ad₂ having a low weighting value.

FIG. 1C is a block diagram that illustrates details of an exemplary processor and memory that may be used in accordance with embodiments of the present invention. In particular, FIG. 1C illustrates an exemplary processor 101 and memory 103 of a message gateway 100, according to some embodiments of the present invention. The processor 101 communicates with the memory 103 via an address/data bus 130. The processor 101 may be, for example, a commercially available or custom microprocessor. Moreover, it will be understood that the processor may include multiple processors. The memory 103 is representative of the overall hierarchy of memory devices containing the software and data used to implement various functions of a message gateway 100 as described herein. The memory 103 may include, but is not limited to, the following types of devices: cache, ROM, PROM, EPROM, EEPROM, flash, SRAM, and DRAM.

As shown in FIG. 1C, the memory 103 may hold various categories of software and data, such as an operating system 143, the advertising database 113, the content database 123, and/or the subscriber database 133. The operating system 143 controls operations of a message gateway 100. In particular, the operating system 143 may manage the resources of the message gateway 100 and may coordinate execution of various programs (e.g., programs to access the advertising database 113) by the processor 101.

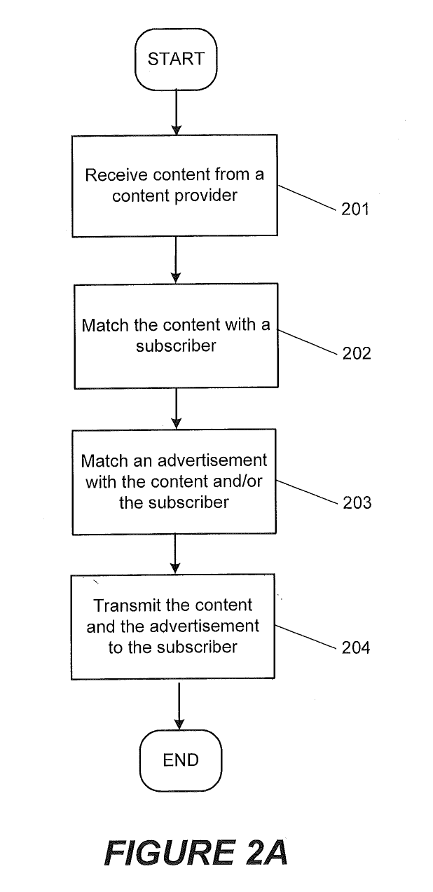

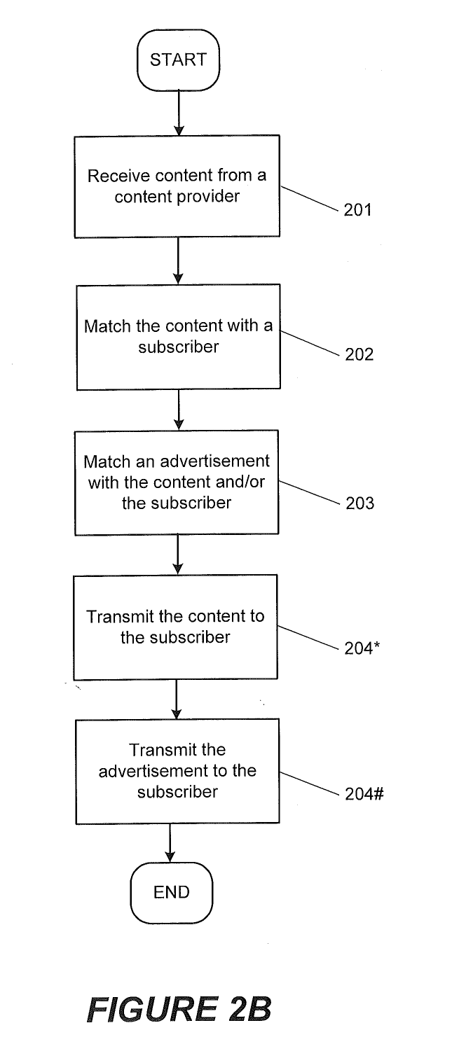

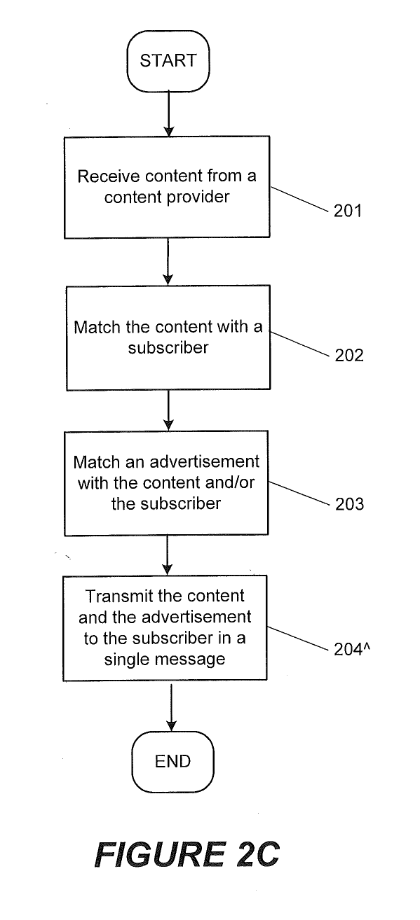

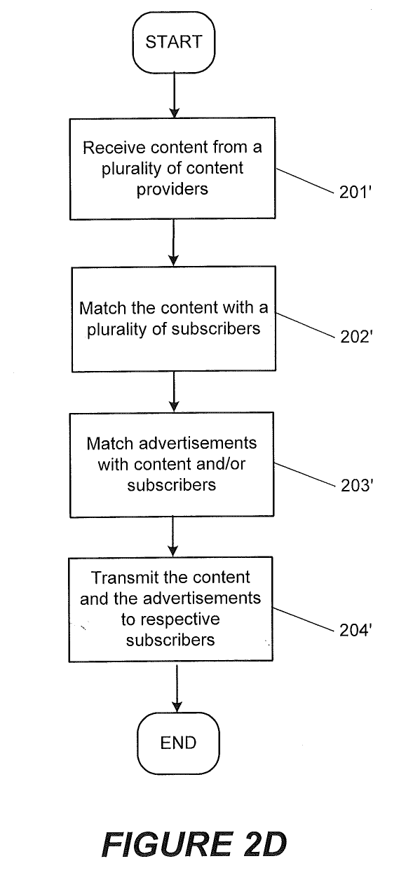

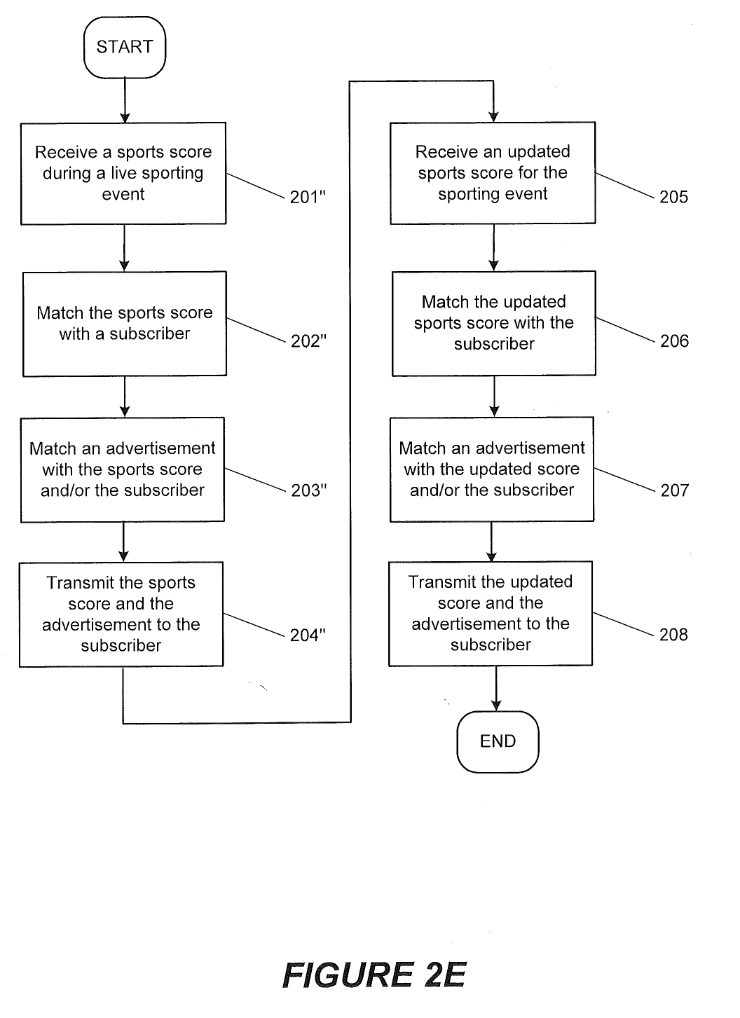

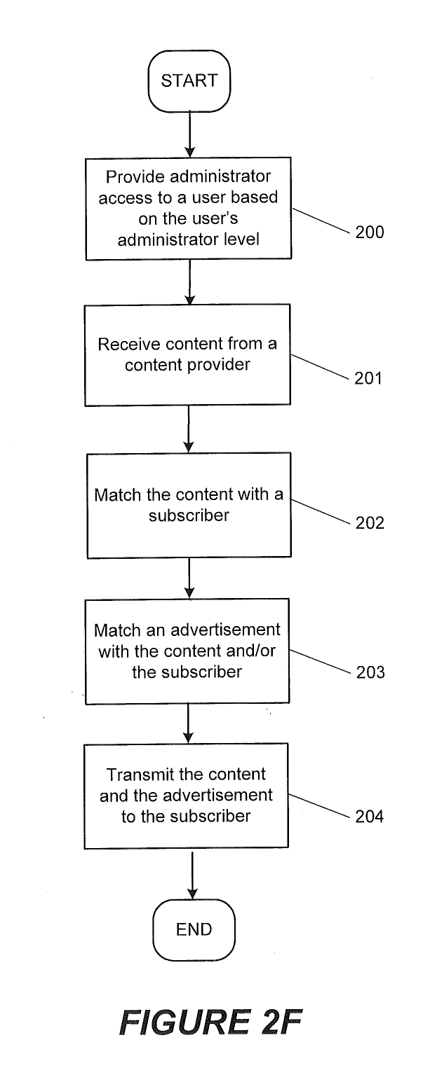

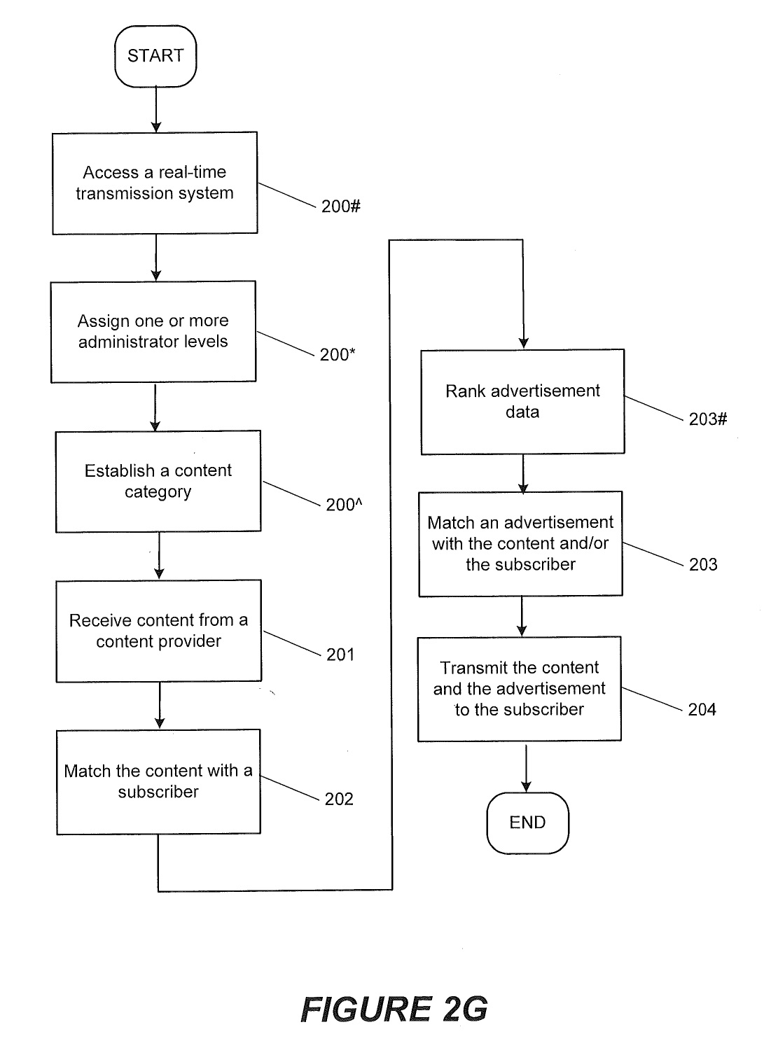

FIGS. 2A-2G are flowcharts illustrating operations of the message gateway 100 of FIG. 1A, according to various embodiments. Referring now to FIG. 2A, operations of the message gateway 100 may include electronically receiving content C from a content provider CP (Block 201). The operations of the message gateway 100 may also include matching the content C with a subscriber S (Block 202). For example, the data management engine 111 may search the subscriber database 133 to match the content C with one or more of the subscribers S₁-Sₙ. The operations of the message gateway 100 may further include matching an advertisement Ad with the content C and/or the subscriber S (Block 203). For example, the data management engine 111 may match the advertisement Ad with the content C and/or one or more of the subscribers S₁-Sₙ. The operations of the message gateway 100 may further include electronically transmitting the content C and the advertisement Ad to the subscriber S (Block 204). For example, the message gateway 100 may transmit the content C and the advertisement Ad to the subscriber S via SMS, MMS, email, mobile application, etc.

Referring now to FIG. 2B, FIG. 2B includes Blocks 201-203 of FIG. 2A, and further includes Blocks 204* and 204#, which are modifications of Block 204 of FIG. 2A. In particular, Block 204* indicates transmitting the content C to the subscriber S, and Block 204# indicates separately transmitting the advertisement Ad to the subscriber S. In other words, Blocks 204* and 204# may indicate separate messages (e.g., separate MMS, SMS, email, or mobile application messages) transmitted to the subscriber S. It will be understood that the content C may be transmitted (Block 204*) either before or after transmitting the advertisement Ad (Block 204#).

Referring now to FIG. 2C, FIG. 2C includes Blocks 201-203 of FIG. 2A, and further includes Block 204̂, which is a modification of Block 204 of FIG. 2A. In particular, Block 204̂ indicates transmitting the content C and the advertisement Ad to the subscriber S in a single (e.g., combined) message. In other words, Block 204̂ indicates transmitting the content C and the advertisement Ad to the subscriber S in the same message.

Referring now to FIG. 2D, FIG. 2D includes Blocks 201′-204′, which are modifications of Blocks 201-204 of FIG. 2A. Although FIGS. 2A-2C indicate “a subscriber” S, it will be understood that the same message gateway 100 may transmit messages including content C₁-Cₙ to a plurality of subscribers S₁-Sₙ. For example, Blocks 201′-204′ indicate a plurality of subscribers S₁-Sₙ. As an example, the message gateway 100 may receive content C₁ from content provider CP₁ and content C₂ from content provider CP₂ (Block 201′). The message gateway 100 may then match the content C₁ and the content C₂ with subscribers S₁-S₅ (Block 202′). For example, the message gateway 100 may match the content C₁ with the subscriber S₁, and may match the content C₂ with the subscribers S₂-S₅.

The message gateway 100 may then match advertisements Ad₁-Ad₃ with the content C₁ and the content C₂ and/or the subscribers S₁-S₅ (Block 203′). For example, the message gateway 100 may match the advertisement Ad₁ with the content C₁, may match the advertisement Ad₂ with the subscribers S₂ and S₃, and may match the advertisement Ad₃ with the subscribers S₄ and S₅. The message gateway 100 may then transmit the content C₁ and the content C₂ and the advertisements Ad₁-A₃ to the subscribers S₁-S₅ (Block 204′). For example, the message gateway 100 may transmit the content C₁ and the advertisement Ad₁ to the subscriber S₁, may transmit the content C₂ and the advertisement Ad₂ to the subscribers S₂ and S₃, and may transmit the content C₂ and the advertisement Ad₃ to the subscribers S₄ and S₅.

Referring now to FIG. 2E, FIG. 2E includes Blocks 201″-204″, which are modifications of Blocks 201-204 of FIG. 2A, and FIG. 2E further includes Blocks 205-208. In particular, FIGS. 201″-208 indicate an example in which content C includes a sports score for a live sporting event. In other words, the message gateway 100 may receive content C including a sports score for a live sporting event from a content provider CP (Block 201″). The content provider CP may be a user and/or electronic device that is physically located at the live sporting event. For example, the content provider CP may include a sports team staff member and/or a computer, a phone, or a scoreboard. Additionally, the content provider CP may have been granted administrator access to the message gateway 100. For example, the content provider CP may have been directly authorized at a specific administrative access level by the message gateway 100 to provide the sports score to the message gateway 100. In another example, the content provider CP may have been authorized at a specific administrative access level by an entity (e.g., a sports team) that has been authorized by the message gateway 100.

The message gateway 100 may match the sports score with a subscriber S, using subscription (e.g., subscriber) data for the subscriber S (Block 202″). Next, the message gateway 100 may match an advertisement Ad with the sports score and/or the subscriber S, using the subscription data for the subscriber S and/or content data included with the sports score (Block 203″). For example, the content data included with the sports score may include the teams or leagues participating in the live sporting event, the location of the live sporting event, and/or the sport itself, etc. Additionally, it will be understood that matching the advertisement Ad with the sports score and/or the subscriber S may include matching the advertisement Ad using advertisement weighting data for the advertisement Ad. The advertisement weighting data may be stored in the message gateway 100. For example, the advertisement Ad₁ may be weighted by the message gateway 100 (e.g., by the data management engine 111) such that it will be transmitted to subscribers S₁-Sₙ more frequently than the advertisement Adₑ. The message gateway 100 may then transmit the sports score and the advertisement Ad to an electronic device of the subscriber S (Block 204″).

Referring still to FIG. 2E, it will be understood that the message gateway 100 may receive and transmit multiple scores during a live sporting event. Accordingly, the message gateway 100 may receive, process, and transmit one or more score updates (Blocks 205-208) after initially transmitting a score (Block 204″). For example, a message gateway 100 may transmit a final score update that may include the final score of the live sporting event after the live sporting event has ended. Moreover, it will be understood that the advertisement Ad transmitted in Block 208 may be the same as the advertisement Ad transmitted in Block 204″, or may be a different advertisement Ad.

Referring now to FIG. 2F, FIG. 2F includes Blocks 201-204 of FIG. 2A, and FIG. 2F further includes Block 200. In particular, Block 200 of FIG. 2F indicates that the message gateway 100 provides administrator access to a user based on the user's administrator level. For example, the user may be a content provider CP. Moreover, before providing the administrator access, the message gateway 100 may assign one or more administrator levels (e.g., the administrator levels illustrated in FIGS. 5A-5C) for accessing the message gateway 100. In particular, the administrator level(s) may include an administrator level for the administrator access granted to the user in Block 200.

Referring now to FIG. 2G, FIG. 2G includes Blocks 201-204 of FIG. 2F, and FIG. 2G further includes Blocks 200#, 200*, and 200̂, which are modifications of Block 200 of FIG. 2F, as well as Block 203#. In particular, Block 200# indicates accessing a real-time transmission system. For example, accessing the real-time transmission system may include accessing the message gateway 100. As an example, an operator/owner of the message gateway 100 may access or set up the message gateway 100. In another example, a content provider CP or an owner/operator of the content provider CP may access the message gateway 100.

Next, the operations of the message gateway 100 may include assigning one or more administrator levels (Block 200*). For example, the operator/owner of the message gateway 100 may assign one or more of the administrator levels illustrated in FIGS. 5A-5C to the content provider CP or an owner/operator of the content provider CP. In another example, the owner/operator of the content provider CP may assign one or more of the administrator levels illustrated in FIGS. 5A-5C to the content provider CP.

Referring still to FIG. 2G, the operations of the message gateway 100 may also include establishing a content-specific data category (Block 200̂). For example, the owner/operator of the message gateway 100 may establish a content-specific data category that may be used by the content provider CP for transmitting content C to the message gateway 100. In another example, the content provider CP or the owner/operator of the content provider CP may establish a content-specific data category that may be used by the content provider CP. Moreover, it will be understood that the operations in Blocks 200#, 200*, and 200̂ may be performed before receiving content C at the message gateway 100 (Block 201).

Additionally, operating the message gateway 100 may include ranking advertisement data (Block 203#). For example, the advertisement Ad₁ may be ranked/weighted by the message gateway 100 (e.g., by the data management engine 111) such that it will be transmitted to the subscribers S₁-Sₙ more frequently than the advertisement Ad₂. Accordingly, matching an advertisement Ad with content C and/or a subscriber S may include using a rank/weight of the advertisement Ad in determining whether to link/combine the advertisement Ad with the content C and/or the subscriber S.

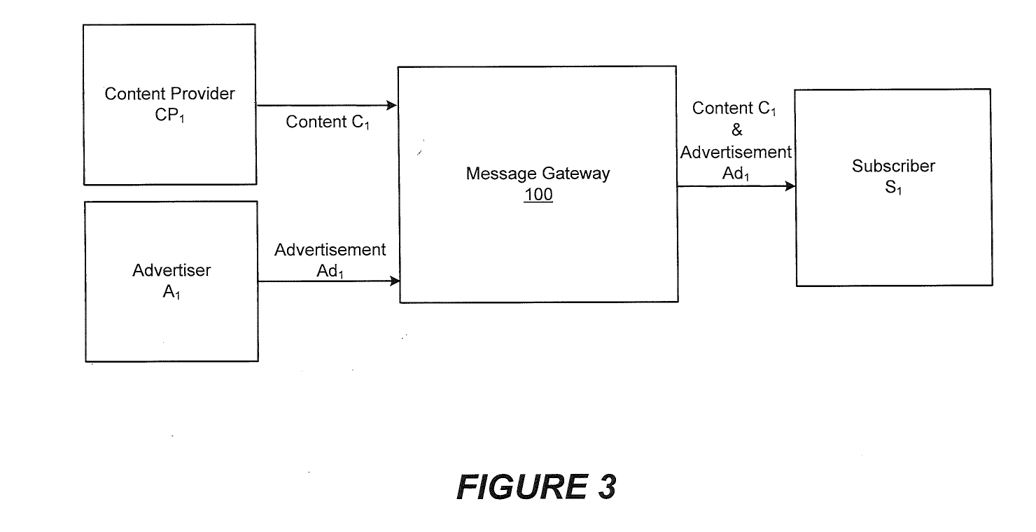

Referring now to FIG. 3, a block diagram is provided illustrating system operations of the message gateway 100 of FIG. 1A, according to various embodiments. In particular, FIG. 3 illustrates that the message gateway 100 may receive content C₁ from content provider CP₁, and may receive advertisement Ad₁ from advertiser A₁. FIG. 3 further illustrates that after matching the content C₁ with the subscriber S₁, and after matching the advertisement Ad₁ with the content C₁ and/or the subscriber S₁, the message gateway 100 may transmit the content C₁ and the advertisement Ad₁ to the Subscriber S₁.

Referring now to FIG. 4, a block diagram is provided of a display 401 of an electronic device 400 of a subscriber S after the subscriber S receives a message from the message gateway 100 of FIG. 1A, according to various embodiments. For example, the message may include content C, which may indicate a score for a basketball game between two small colleges X and Y. The content C may indicate an amount of time remaining in the basketball game and/or other game details. The message may include an advertisement Ad.

Referring now to FIGS. 5A-5C, lists of capabilities of different administrative levels for the message gateway 100 of FIG. 1A are illustrated, according to various embodiments. In particular, FIG. 5A lists capabilities of a full-access (“super admin”) administrative level administrator, FIG. 5B lists capabilities of a mid-level administrative level administrator, and FIG. 5C lists capabilities of a bottom-level (“basic”) administrator (e.g., a scorecaster for sports games/events). It will be understood that the capabilities listed in FIGS. 5A-5C are provided as examples, and are not intended to be limiting. For example, although the list of capabilities of the full-access administrative level administrator illustrated in FIG. 5A indicates items (a)-(u), it will be understood that a user having the full-access administrative level may be capable of any one of the items (a)-(u), multiple ones of the items (a)-(u), or all of the items (a)-(u). Moreover, it will be understood that the user having the full-access administrative level may have additional capabilities beyond the items (a)-(u) indicated in FIG. 5A. Furthermore, it will be understood that using the administrative levels illustrated in FIGS. 5A-5C may improve the accuracy/quality of content C by limiting access to the message gateway 100.

Accordingly, in various embodiments, a real-time data transmission system (e.g., the message gateway 100) may include a computer-implemented content management interface that includes at least one administrative control for at least one administrative level. The phrase “administrative controls” as used herein refers to any mechanism to limit access to the system and/or interface, often at a particular administrator level. The phrase “administrative level” as used herein refers to a predetermined level of access granted to the administrator and/or subscriber S. The administrator may be an owner/operator of the message gateway 100, a content provider CP, an owner/operator of the content provider CP, or an advertiser A. In various embodiments, administrative controls may be accessible by any one or more of a user name, password, email address, security certificate, barcode, key card, and/or personal identifier, among others.

In various embodiments, a real-time data transmission system may be secured through administrative controls. The system may include a computer-implemented content management interface including any one or more of a macro and template for content-specific data entry. The system may also include a subscriber database 133 including subscriber data including at least one content-specific identifier, an advertisement/advertisement database 113 including advertisement data (e.g., advertisements Ad₁-Adₙ) including at least one target identifier, and a data management engine 111 in operative communication with the computer-implemented interface, the subscriber database 133, and the advertisement database 113. The data management engine 111 may be configured to transmit content-specific data (e.g., content C₁-Cₙ) and advertisement data to one or more subscribers S₁-Sₙ based on the subscriber data, where the computer-implemented content management interface may further include at least one administrative control associated with at least one administrative level (e.g., the administrative levels illustrated in FIGS. 5A-5C).

Although various examples herein are described in the context of sports, it will be understood that the disclosure may also have applications outside of sports. For example, in various embodiments, whether within or outside of a sports context, a secure server may be provided for handling any one or more of (a) the content-specific data (e.g., data in the content database 123), (b) the subscriber database 133, and (c) the advertisement/advertising database 113. The data management engine 111 may be in operative communication with the computer-implemented interface, subscriber database 133, and/or advertisement/advertising database 113. The data management engine 111 may be configured to transmit content-specific data and advertisement data to one or more subscribers S₁-Sₙ based on the subscriber data. For example, a subscriber S may be an employee of a company and may receive content-specific data (e.g., related to the company's closing due to weather). An advertisement Ad may be coupled with or follow the content-specific data transmission. As an example, the advertisement Ad may be for weather-specific clothing based on a target identifier.

In another example, a medical group (e.g., a physician office or a dental office) may be a content provider CP that provides patient appointment reminders to patients and/or staff of the medical group. Accordingly, subscribers S₁-Sₙ may be patients and/or staff of the medical group, and may receive advertisements Ad₁-Adₙ along with the patient appointment reminders. Moreover, as content C transmitted about a patient may include sensitive information, messages received by the subscribers S₁-Sₙ from the medical group may be encrypted. For example, a subscriber S may load/install an application (e.g., a small utility application) on the subscriber S's electronic device 400 to decrypt encrypted SMS messages from the medical office. Furthermore, it will be understood that non-medical entities, such as non-medical companies providing messages to their employees, may also use encrypted messages.

In yet another example, a business may be a content provider CP that provides news/updates about the business' latest offerings, products, and specials to subscribers S₁-Sₙ (e.g., customers of the business). In a further example, a media outlet (e.g., a radio station, television station, or newspaper) may be a content provider CP that provides messages to subscribers S₁-Sₙ (e.g., the media outlet's audience). For example, a media outlet may provide content C to its audience to conduct polls relative to the audience, and/or to provide news alerts, weather alerts, information about promotions by the media outlet, and/or community events to the audience.

In an additional example, a business may be a content provider CP that sends messages to tourists/vacationers to notify the tourists/vacationers of available coupons, promotions, and/or other information. For example, the business may be a golf course that sends content C about tee times to a subscriber S staying at a nearby/affiliated resort. Accordingly, the message gateway 100 may facilitate messages to the subscriber S that provide concierge-like services.

Moreover, although various examples herein are described in the context of MMS, SMS, and email messages, it will be understood that the data management engine 111 may additionally or alternatively transmit content-specific data to one or more subscribers S₁-Sₙ through a web portal. In various embodiments, a web portal may include a secure network portal for securely connecting a subscriber terminal and computer-implemented content management interface.

It is to be appreciated that any of the elements and features described herein may be combined with any one or more other elements and features.

While the disclosure has been has been described herein in reference to specific aspects, features and illustrative embodiments of the disclosure, it will be appreciated that the utility of the disclosure is not thus limited, but rather extends to and encompasses numerous other variations, modifications and alternative embodiments, as will suggest themselves to those of ordinary skill in the field of the present disclosure, based on the disclosure herein. Correspondingly, the invention as hereinafter claimed is intended to be broadly construed and interpreted, as including all such variations, modifications and alternative embodiments, within its spirit and scope.

What is claimed is:

1. A real-time data transmission system secured through administrative controls, the system comprising:
a computer-implemented content management interface that includes a macro and/or a template configured to receive content-specific data entry from a content provider, and that includes at least one administrative control associated with at least one administrative level;
a subscriber database including subscriber data that includes at least one content-specific identifier;
an advertisement database that is configured to manage advertisement data that includes at least one target identifier; and
a data management engine in operative communication with the computer-implemented interface, subscriber database, and/or advertisement database, and that is configured to transmit content-specific data and advertisement data to a subscriber based on the subscriber data.

2. The system of claim 1, further comprising a computer-implemented content display interface configured to display the content-specific data.

3. The system of claim 1, further comprising a secure server configured to handle any one or more of (a) the content-specific data, (b) the subscriber database, and (c) the advertisement database.

4. The system of claim 1, further comprising a web portal configured to transmit the content-specific data to the subscriber.

5. The system of claim 1, wherein the computer-implemented content management interface further includes a direct-connect portal to a data entry control.

6. The system of claim 5, wherein the data entry control comprises any one or more of a scoreboard, scoreboard controller, emergency alert system, academic alert system, weather alert system, news alert system, switchboard, and messaging system.

7. The system of claim 1, wherein the subscriber data includes any one or more of a subscriber name, address, telephone number, account number, email address, parental information, student information, teacher information, sports interest information, alumni information, coach information, administrator information, fantasy league information, hobbies, mobile number, company information, academic information, medical information, organization information, and religious information.

8. The system of claim 1, wherein the at least one target identifier is associated with the subscriber data.

9. The system of claim 1, wherein the data management engine transmits the content-specific data and advertisement data through any one or more of SMS, encrypted SMS, MMS, email, mobile applications, and web page delivery.

10. The system of claim 1, wherein the at least one administrative control is accessible by any one or more of a user name, password, email address, security certificate, barcode, key card, and personal identifier.

11. A computer-implemented method of real-time data transmission, the method comprising:
accessing a real-time data transmission system through an administrative control;
establishing a first-level content-specific data category in a computer-implemented content management interface;
generating a second-level content-specific data associated with the first-level content-specific data category;
using a data management engine to transmit the second-level content-specific data to one or more subscribers in a subscriber database, wherein subscriber data includes at least one content-specific identifier associated with any one or more of the first-level content-specific data category and the second-level content-specific data; and
transmitting to the one or more subscribers advertisement data that includes at least one target identifier associated with any one or more of the subscriber data, the at least one content-specific identifier, the first-level content-specific data category, and the second-level content-specific data.

12. The method of claim 11, further comprising assigning one or more administrator levels that provide access to the real-time data transmission system.

13. The method of claim 11, further comprising ranking the advertisement data based on any one or more of the target identifier, weighting value, and date.

14. The method of claim 11, wherein the first-level content-specific data category comprises any one or more of a school, league, conference, team, company, organization, and government entity.

15. The method of claim 11, wherein the second-level content-specific data comprises any one or more of a score, game update, media report, weather report, medical alert, weather alert, announcement, and notice.

16. A method of operating a message gateway, comprising:
receiving, at the message gateway, a sports score of a live sporting event from a content provider that is a user and/or an electronic device that is physically located at the live sporting event, and that has administrator access to the message gateway;
matching the sports score with a subscriber, using subscription data corresponding to the subscriber;
matching an advertisement with the sports score and/or the subscriber, using the subscription data corresponding to the subscriber and/or content data included with the sports score; and
transmitting the sports score and the advertisement to an electronic device of the subscriber.

17. The method of claim 16, wherein matching the advertisement with the sports score and/or the subscriber comprises matching the advertisement, using advertisement weighting data corresponding to the advertisement stored in the message gateway.

18. The method of claim 16, wherein the advertisement comprises a first advertisement, the method further comprising:
receiving an updated sports score of the live sporting event;
matching the updated sports score with the subscriber, using the subscription data;
matching a second advertisement with the updated sports score and/or the subscriber, using the subscription data corresponding to the subscriber and/or content data included with the updated sports score; and
transmitting the updated sports score and the second advertisement to the electronic device of the subscriber.

19. The method of claim 16, wherein transmitting the sports score and the advertisement to the electronic device of the subscriber comprises transmitting the sports score and the advertisement to the electronic device of the subscriber in a single electronic message.

20. The method of claim 16, further comprising:
before receiving the sports score, assigning one or more administrator levels that provide access to the message gateway, wherein the one or more administrator levels include an administrator level corresponding to the administrator access granted to the content provider.
